(19) United States
(12) Patent Application Publication
(10) Pub. No.: US 2012/0108298 A1
(43) Pub. Date: May 3, 2012

(54) PORTABLE DEVICE HAVING A VIRTUAL DISPLAY

(75) Inventors: Nicole Tricoukes, Seaford, NY (US); Thomas K. Roslak, Northport, NY (US); Jorg Schlieffers, Abingdon (GB)

(73) Assignee: Symbol Technologies, Inc., Schaumburg (DE)

(21) Appl. No.: 12/915,225

(22) Filed: Oct. 29, 2010

(51) Int. Cl. H04W 88/02; G06F 1/16

(52) U.S. Cl. 455/566; 361/679.26

(57) ABSTRACT

A mobile device is described. The mobile device includes a housing and a processor positioned within the housing for processing data related to the mobile device. An integrated display is coupled to the processor for displaying the data related to the mobile device. A micro-display is coupled to the housing. The micro-display includes an optical element that creates a virtual display having a larger appearance than the integrated display when the optical element is positioned proximate to an eye of a user.

### TECHNICAL FIELD

The invention relates generally to displaying data with a mobile computing device.

### BACKGROUND

Mobile computers having integrated displays are widespread. The displays on these mobile computers are generally a few inches in diameter. Generally, these small displays are not ideal for viewing large images or documents. A zoom feature is sometimes provided to allow a user view a small section of the image. The user can then scroll around the image using an input device to view other sections of the image.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a front view of a mobile computing device according to one embodiment of the invention.

FIG. 2 is a block diagram illustrating the electronic components of the mobile computing device of FIG. 1.

FIG. 3 is a perspective view of a mobile computing device according to one embodiment of the invention.

FIG. 4 is a cross-sectional view of a detachable micro-display module according to one embodiment of the invention.

FIG. 5 is a perspective view of a mobile computing device according to another embodiment of the invention.

FIG. 6 is a perspective view of a mobile computing device according to another embodiment of the invention.

### SUMMARY

In one aspect, the invention is embodied in a mobile device including a housing. A processor is positioned within the housing. The processor processes data related to the mobile device. An integrated display is coupled to the processor for displaying the data related to the mobile device. A micro-display is coupled to the housing. The micro-display includes an optical element that creates a virtual display having a larger appearance than the integrated display when the optical element is positioned proximate to an eye.

In one embodiment, the micro-display is detachably coupled to the housing. The mobile device can be a two-way radio, a mobile computer, a cellular telephone or a satellite telephone. The integrated display can include a touch screen display. The integrated display can be a liquid crystal display (LCD).

The mobile device can also include an input device that is coupled to the processor. The input device can be a touch screen display, a keypad, a microphone, a joystick, a trackball, a thumbwheel, an optical mouse, a touch pad, an optical control, and/or a pointing device. In one embodiment, the mobile device includes a diopter that is optically coupled to the optical element. The optical element can include a plurality of optical components.

In some embodiments, the mobile device can include one or more of the following components: a digital compass, a gyroscope, an accelerometer or a global positioning system (GPS) module that is rigidly coupled to the housing for tracking a movement of the housing.

In one embodiment, the data can be displayed on both the integrated display and the micro-display substantially simultaneously. In another embodiment, the data can be displayed on the micro-display while the integrated display functions as an input device.

In another aspect, the invention is embodied in a method of displaying data from a mobile device. The method includes processing data related to a mobile device and displaying the data on an integrated display of the mobile device. A micro-display having an optical element is coupled to the mobile device. The optical element creates a virtual display having a larger appearance than the integrated display. The data is displayed on the micro-display such that the data is viewable through the optical element.

In one embodiment, the micro-display is detachably coupled to the mobile device. In another embodiment, the micro-display is integrated with the mobile device. The method can also include inputting data through the integrated display. A diopter can be coupled to the optical element.

In one embodiment, the movement of the mobile device is tracked with one or more of a digital compass, a gyroscope, an accelerometer or a global positioning system (GPS) module that is rigidly coupled to the mobile device. In one embodiment, the data can be displayed on both the integrated display and the micro-display substantially simultaneously. The method can also include providing input through the integrated display when the data is displayed on the micro-display.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional image-based capture, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to portable devices utilizing multiple displays. In an exemplary embodiment, a micro-display is coupled to a mobile device, such as a mobile computer. An optical element is coupled to the micro-display. The micro-display is capable of presenting a large virtual display to a user.

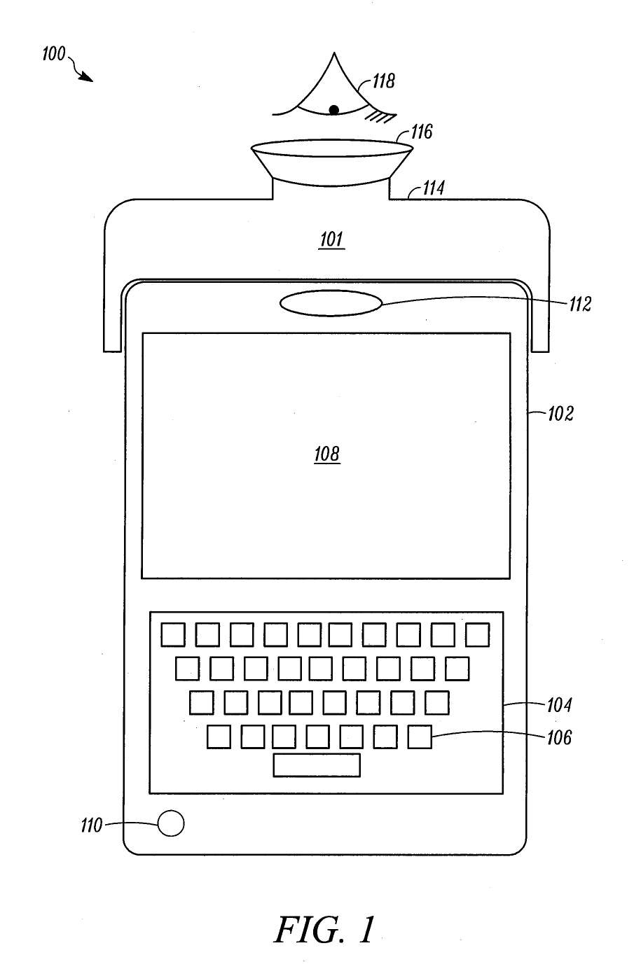

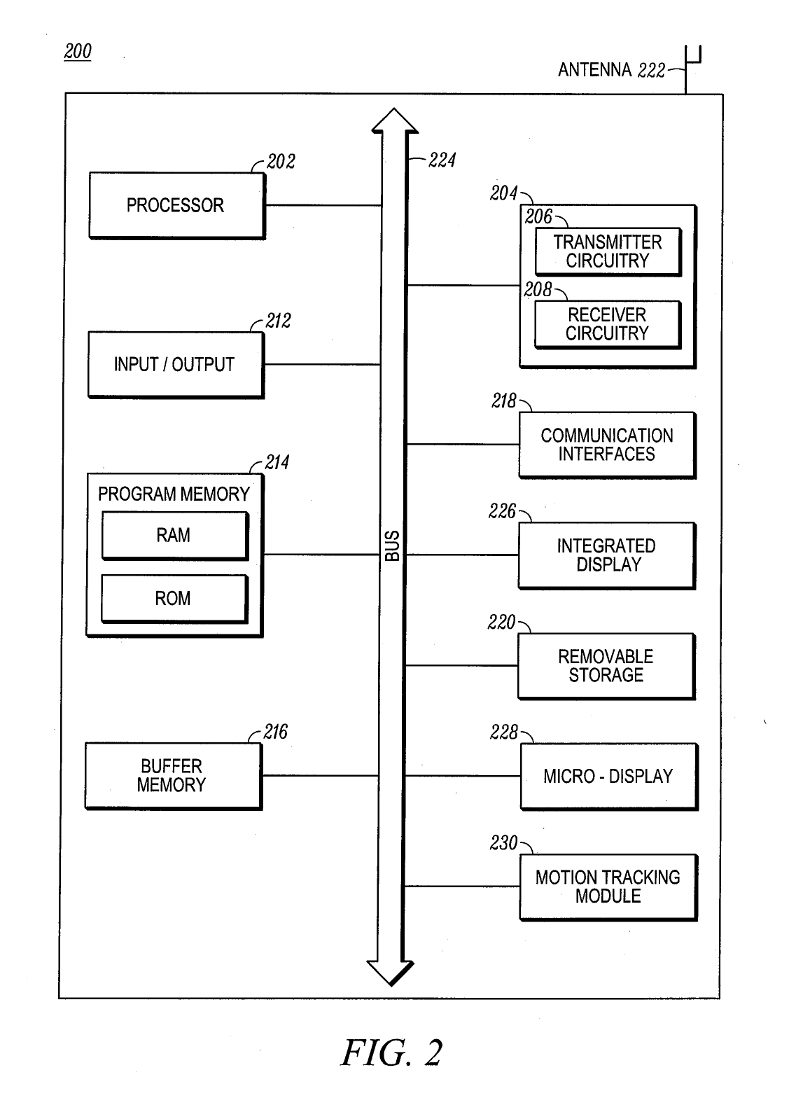

FIG. 1 is a front view of a mobile computing device 100 according to one embodiment of the invention. The mobile computing device 100 is one example of a device having a detachable micro-display module 101 according to the invention. The mobile device 100 can be a two-way radio, a mobile computer, a personal digital assistant (PDA), a cellular telephone or a satellite telephone, for example. The mobile computing device 100 includes a housing 102. The housing 102 contains electronic components, including internal communication components and circuitry as further described with relation to FIG. 2 to enable the device 100 to function and to communicate wirelessly with other devices. The housing 102 also contains I/O devices such as a keyboard 104 with alpha-numeric keys 106, an integrated display 108 (e.g., LED, OELD) that displays information about the device 100, soft and/or hard keys, touch screen, a joystick, a trackball, a thumbwheel, an optical mouse, a touch pad, a jog wheel, an optical control, and/or a pointing device, a microphone 110, and a speaker 112. In one embodiment, the detachable micro-display module 101 includes a diopter (not shown) that is optically coupled to a micro-display (not shown) within the detachable micro-display module 101. The diopter can be used to adjust a focus of the micro-display. For example, the diopter adjusts the focus for individual differences in the vision of each user. The detachable micro-display module 101 also includes an optical element (not shown) that can be formed from a plurality of optical components.

The detachable micro-display module 101 includes a housing 114. The housing 114 mechanically mates with the housing 102 of the mobile computing device 100 such that the detachable micro-display module 101 is removably coupled to the mobile computing device 100. The detachable micro-display module 101 also includes an eyecup 116 for shielding the micro-display from extraneous light. In operation, a user positions an eye 118 proximate to the eyecup 116 and adjusts the focus of the micro-display with the diopter. In some embodiments, the device 100 includes more or less than all of the I/O devices shown in FIG. 1.

FIG. 2 is a block diagram 200 illustrating the electronic components of the mobile computing device 100 (FIG. 1) according to the invention. The mobile computing device 100 contains, among other components, a processor 202, a transceiver 204 including transmitter circuitry 206 and receiver circuitry 208, an antenna 222, the I/O devices 212 described in relation to FIG. 1, a program memory 214 for storing operating instructions that are executed by the processor 202, a buffer memory 216, one or more communication interfaces 218, an integrated display 226, an optional removable storage 220, and a micro-display 228 coupled to the mobile computing device 100. The mobile computing device 100 can also include a motion tracking module 230 that is rigidly coupled to the housing 102 (FIG. 1) for tracking a movement of the housing 102, for example. The motion tracking module 230 can include one or more of an accelerometer, a gyroscope, a global positioning system (GPS) module, magnetometer, and digital compass, for example. Other suitable components can also be used. In some embodiments, the motion tracking module 230 can be used to track a location and/or an orientation of the mobile computing device 100.

In one embodiment, the mobile computing device 100 is an integrated unit containing the components depicted in FIG. 2, as well as any other component necessary for the mobile computing device 100 to function. In one embodiment, the electronic components are connected by a bus 224.

The processor 202 can include one or more microprocessors, microcontrollers, DSPs, state machines, logic circuitry, or any other device or devices that process information based on operational or programming instructions. Such operational or programming instructions are preferably stored in the program memory 214. The program memory 214 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 202 has one or more of its functions performed by a state machine or logic circuitry, the program memory 214 containing the corresponding operational instructions may be embedded within the state machine or logic circuitry. Operations performed by the processor 202 as well as the mobile computing device 100 are described in detail below.

The transmitter circuitry 206 and the receiver circuitry 208 enable the mobile computing device 100 to respectively transmit and receive communication signals. In this regard, the transmitter circuitry 206 and the receiver circuitry 208 include circuitry to enable wireless transmissions. The implementations of the transmitter circuitry 206 and the receiver circuitry 208 depend on the implementation of the mobile computing device 100 and the devices with which it is to communicate. For example, the transmitter and receiver circuitry 206, 208 can be implemented as part of the communication device hardware and software architecture in accordance with known techniques. One of ordinary skill in the art will recognize that most, if not all, of the functions of the transmitter or receiver circuitry 206, 208 can be implemented in a processor, such as the processor 202. However, the processor 202, the transmitter circuitry 206, and the receiver circuitry 208 have been partitioned herein to facilitate a better understanding of the functions of these elements. In one embodiment, the antenna 222 is a local area network (LAN) antenna coupled to the transceiver 204.

The buffer memory 216 may be any form of volatile memory, such as RAM, and is used for temporarily storing information received from the data capture device 226, for example. The removable memory 220 can be a secure digital (SD) memory card, for example.

The integrated display 226 displays data generated by software applications residing in the memory 214 and executing on the processor 202. The integrated display 226 can be a liquid crystal display (LCD) or any other suitable display. In one embodiment, the integrated display 226 is a touch screen display having user input capabilities. For example, the user can touch the surface of the integrated display 226 to activate a function of the device 100.

A micro-display 228 is coupled to the device 100. The micro-display 228 can be removably coupled to the device 100 such that it is detachable by a user. Alternatively, the micro-display 228 can be integrated with the device 100. In one embodiment, the micro-display 228 includes an optical element (not shown) that is optically coupled to the micro-display 228. In one embodiment, the micro-display 228 including the optical element creates a virtual display when the optical element is positioned proximate to an eye of a user. For example, depending on the properties of the optical element, the micro-display 228 including the optical element can create a large virtual display having a diagonal dimension of between ten and twenty-two inches. In practice, the virtual display can be any desired size depending on the optical element.

In one mode of operation, data is displayed on both the integrated display 226 and the micro-display 228. Alternatively, if the mobile device 100 is oriented to allow a user to view the virtual display generated by the micro-display 228, the integrated display 226 can be deactivated. In one embodiment, the integrated display 226 including touch screen functionality can be used as an input device when the user is viewing the virtual display generated by the micro-display 228.

The processor 202 issues commands via the program memory 214 to deactivate the integrated display 226 in response to a signal from the motion tracking module 230. The signal indicates that the mobile computing device 100 is oriented to allow a user to view the virtual display generated by the micro-display 228. In one embodiment, the program memory 214 is implemented within a field programmable gate array (FPGA), however the program memory 214 may also be implemented in other devices. In one embodiment, the memory module stores data prior to the processor 202 instructing the integrated display 226 and/or the micro-display 228 to display the data.

As previously described, the micro-display 228 can be a module that is removably coupled to the mobile computing device 100. Alternatively, the micro-display 228 can be integrated with the mobile computing device 100. In operation, data processed by the processor 202 can be displayed on the integrated display 226 and/or the micro-display 228 of the mobile device 100.

The micro-display 228 can be coupled to a housing of the mobile computing device 100. By coupled, we mean that the micro-display 228 can be integrated into the housing or can be detachably coupled to the housing. The micro-display 228 including an optical element (not shown) creates a virtual display having a larger appearance than the integrated display 226 when the optical element is positioned proximate to an eye of the user. The optical element can be formed from one or more optical components such as lenses, prisms, beam splitters, and/or mirrors, for example.

In one embodiment, the data can be displayed on both the integrated display 226 and the micro-display 228 substantially simultaneously. In another embodiment, the data can be displayed on the micro-display 228 while the integrated display 226 functions as an input device for inputting user commands, for example.

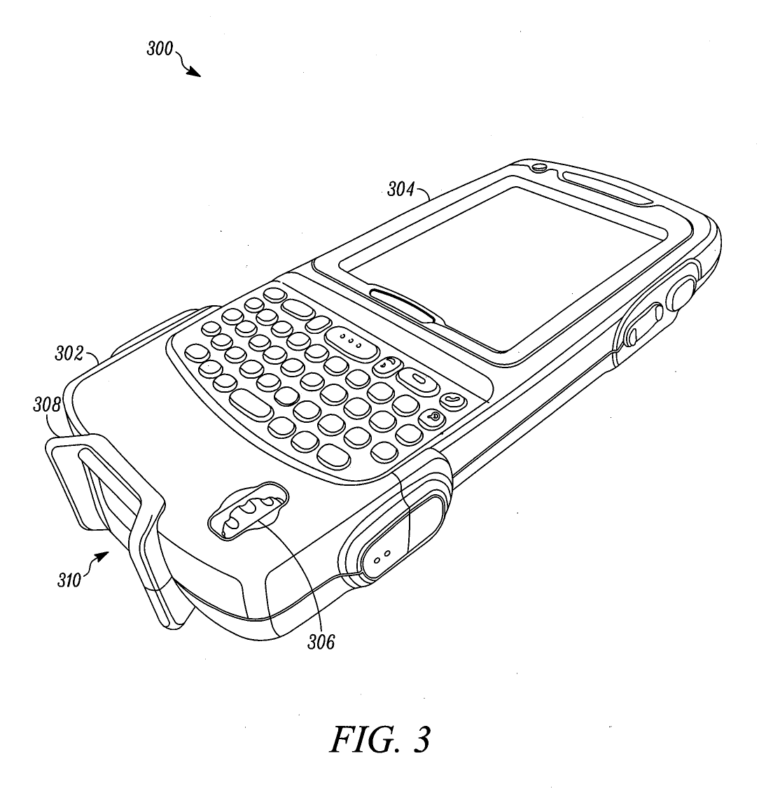

FIG. 3 is a perspective view of a mobile computing device 300 according to one embodiment of the invention. The mobile computing device 300 includes the detachable micro-display module 302. The detachable micro-display module 302 is coupled to the housing 304 of the mobile computing device 300. The micro-display module 302 includes the optical element (not shown) integrated within the micro-display module 302. The micro-display module 302 also includes the diopter (not shown) for fine focusing of the micro-display integrated within the micro-display module 302. In one embodiment, the diopter is adjusted via a thumbwheel 306. As the thumbwheel 306 is rotated, the diopter is translated linearly with respect to the optical element. In practice, diopter can be adjusted using a conventional threaded mount that allows the diopter to translate linearly as it is rotated.

The micro-display module 302 also includes an eyecup 308. The eyecup 308 is used to shield the micro-display from extraneous light that could affect the image of the virtual display. In one embodiment, the eyecup 308 is fabricated from a rubber material. In practice, any suitable material can be used. The micro-display module 302 can also include a cover (not shown) that covers and protects the viewing window 310 when the micro-display module 302 is not in use.

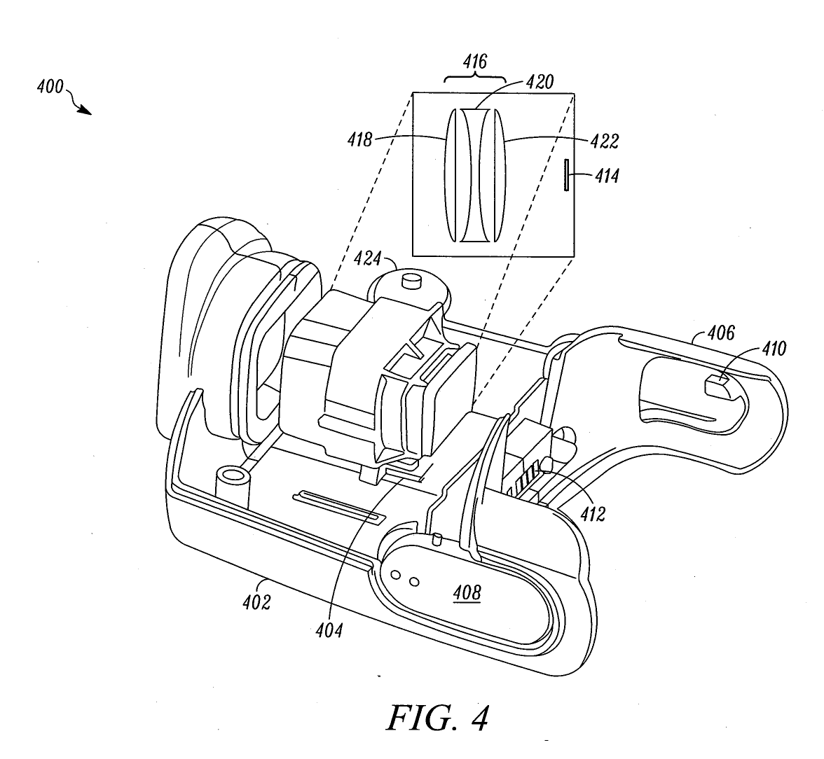

FIG. 4 is a cross-sectional view of a detachable micro-display module 400 according to one embodiment of the invention. The micro-display module 400 includes a housing 402 that is configured to mate with the housing 304 (FIG. 3) of the mobile computing device 300. A processing board 404 is coupled to the housing 402 of the module 400. The processing board 404 can include components (not shown) that are necessary to activate the micro-display module 400. The housing 402 includes a mechanical coupler 406 having latches 408, 410 for securing the micro-display module 400 to the housing 304 of the mobile device 300. The processing board 404 can include an electrical connector 412 that mates with an electrical connector (not shown) of the mobile device.

In one embodiment, the detachable micro-display module 400 can include a transceiver for wirelessly communicating with the mobile device 300. In this embodiment, the detachable micro-display module 400 functions as a standalone unit that is mechanically coupled to the mobile device 300, but communicates with (e.g., receives video signals from) the mobile device 300 through a wireless interface, such as a Bluetooth or a Zigbee interface, for example. The detachable micro-display module 400 can also include a battery, video processing circuitry, and an optional memory module.

In general, the processing board 404 includes a processor having processing logic configured to carry out the functions, techniques, and processing tasks associated with the operation of the mobile device. Furthermore, the steps of a method or algorithm described in connection with the embodiments disclosed herein may be embodied directly in hardware, in firmware, in a software module executed by the processor, or any combination thereof Any such software may be implemented as low level instructions (assembly code, machine code, etc.) or as higher-level interpreted or compiled software code (e.g., C, C++, Objective-C, Java, Python, etc.).

The micro-display module 400 can also include a micro-display component 414. The micro-display component 414 is generally a small display that displays an image that is not discernable with the naked eye. For example, a magnifying element must be used for a user to view a discernable image on the micro-display component 414.

An optical element 416 is optically coupled to the micro-display component 414. The optical element 416 can include one or more optical components 418, 420, 422. The optical element 416 creates a virtual image when an eye of a user is positioned proximate to the optical element 416. The optical element 416 can also include a diopter (not shown) having a rotatable control 424.

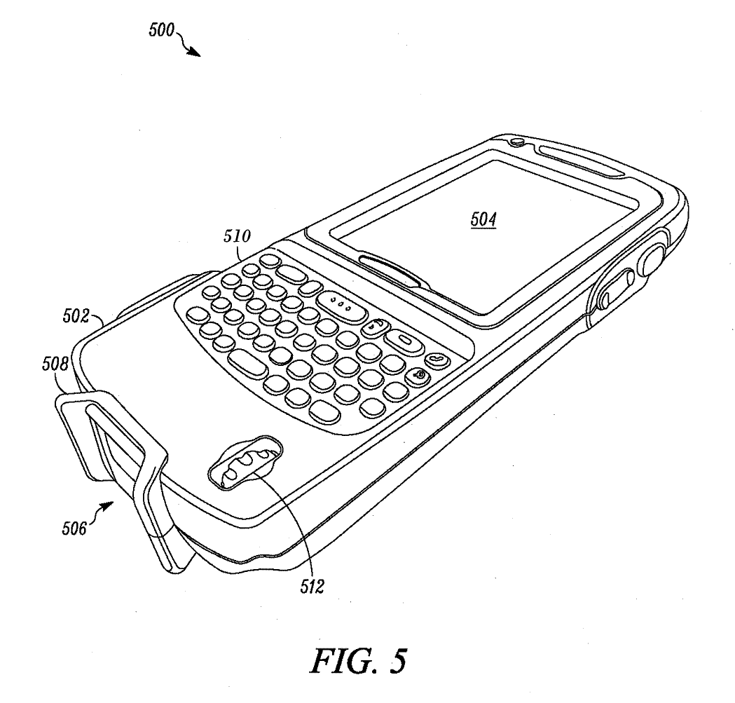

FIG. 5 is a perspective view of a mobile computing device 500 according to another embodiment of the invention. The mobile computing device 500 includes a housing 502. A processor (not shown) is positioned within the housing 502. The processor processes data related to the mobile computing device 500. An integrated display 504 is coupled to the processor for displaying the data related to the mobile computing device 500. A micro-display 506 is coupled to the housing 502. The micro-display 506 includes an optical element (not shown) that creates a virtual display having a larger appearance than the integrated display 504 when the optical element is positioned proximate to an eye of a user. The housing 502 includes a rubber eyecup 508.

The integrated display 504 can include a touch screen display. The integrated display 504 can be a liquid crystal display (LCD). The mobile computing device 500 can also include an input device such as a keypad 510 that is coupled to the housing 502. The input device can also be a touch screen display, a microphone, a joystick, a trackball, a thumbwheel, an optical mouse, a touch pad, an optical control, and/or a pointing device. In one embodiment, the mobile computing device 500 includes a diopter (not shown) that is optically coupled to the optical element. The diopter can be adjusted via a thumbwheel 512. The optical element can include a plurality of optical components.

In one embodiment, the data can be displayed on both the integrated display 504 and the micro-display 506 substantially simultaneously. In another embodiment, the data can be displayed on the micro-display 506 while the integrated display 504 functions as an input device.

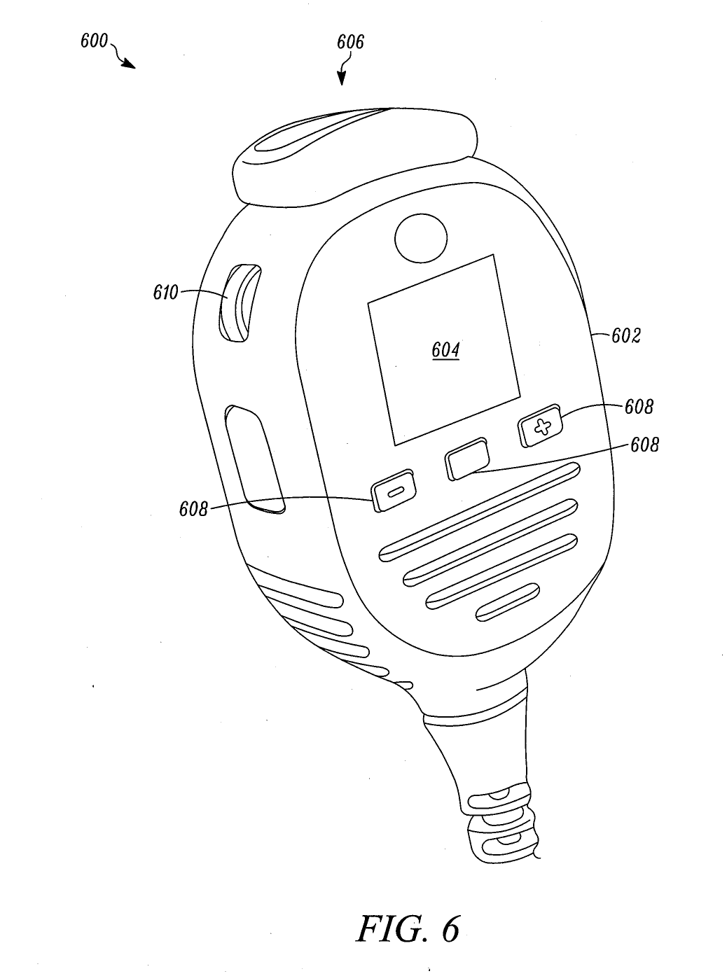

FIG. 6 is a perspective view of a mobile computing device 600 according to another embodiment of the invention. The mobile computing device 600 includes a housing 602. The housing 602 is shaped like a microphone for a citizens band (CB) radio or a microphone for a police or fire radio. A processor (not shown) is positioned within the housing 602. The processor processes data related to the mobile computing device 600. An integrated display 604 is coupled to the processor for displaying the data related to the mobile computing device 600. A micro-display 606 is coupled to the housing 602. The micro-display 606 includes an optical element (not shown) that creates a virtual display having a larger appearance than the integrated display 604 when the optical element is positioned proximate to an eye of a user.

The integrated display 604 can include a touch screen display. The integrated display 604 can be a liquid crystal display (LCD). The mobile computing device 600 can also include an input device such as one or more input keys 608 that are coupled to the housing 602. The input device can also be a touch screen display, a microphone, a joystick, a trackball, a thumbwheel, an optical mouse, a touch pad, an optical control, and/or a pointing device. In one embodiment, the mobile computing device 600 includes a diopter (not shown) that is optically coupled to the optical element. The diopter can be adjusted via a thumbwheel 610. The optical element can include a plurality of optical components.

In one embodiment, the data can be displayed on both the integrated display 604 and the micro-display 606 substantially simultaneously. In another embodiment, the data can be displayed on the micro-display 606 while the integrated display 604 functions as an input device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile device, comprising:
a housing;
a processor positioned within the housing for processing data related to the mobile device;
an integrated display coupled to the processor for displaying the data related to the mobile device; and
a micro-display coupled to the housing, the micro-display including an optical element that creates a virtual display having a larger appearance than the integrated display when the optical element is positioned proximate to an eye.

2. The mobile device of claim 1, wherein the micro-display is detachably coupled to the housing.

3. The mobile device of claim 1, wherein the mobile device is chosen from the group comprising a two-way radio, a mobile computer, a cellular telephone and a satellite telephone.

4. The mobile device of claim 1, wherein the integrated display comprises a touch screen display.

5. The mobile device of claim 1, further comprising an input device coupled to the processor, the input device being chosen from the group comprising a touch screen display, a keypad, a microphone, a joystick, a trackball, a thumbwheel, an optical mouse, a touch pad, an optical control, and a pointing device.

6. The mobile device of claim 1, wherein the integrated display comprises a liquid crystal display (LCD).

7. The mobile device of claim 1, further comprising a diopter optically coupled to the optical element.

8. The mobile device of claim 1, wherein the optical element comprises a plurality of optical components.

9. The mobile device of claim 1, further comprising at least one of a digital compass, a gyroscope, an accelerometer and a global positioning system (GPS) module that is rigidly coupled to the housing for tracking a movement of the housing.

10. The mobile device of claim 1, wherein the data is displayed on both the integrated display and the micro-display substantially simultaneously.

11. The mobile device of claim 1, wherein when the data is displayed on the micro-display, the integrated display functions as an input device.

12. A method comprising:
processing data related to a mobile device;
displaying the data on an integrated display of the mobile device;
coupling a micro-display having an optical element to the mobile device, the optical element creating a virtual display having a larger appearance than the integrated display; and
displaying the data on the micro-display such that the data is viewable through the optical element.

13. The method of claim 12, wherein the micro-display is detachably coupled to the mobile device.

14. The method of claim 12, further comprising inputting data through the integrated display.

15. The method of claim 12, further comprising optically coupling a diopter to the optical element.

16. The method of claim 12, further comprising tracking a movement of the housing with at least one of a digital compass, a gyroscope, an accelerometer and a global positioning system (GPS) module that is rigidly coupled to the mobile device.

17. The method of claim 12, wherein the data is displayed on both the integrated display and the micro-display substantially simultaneously.

18. The method of claim 12, further comprising providing input through the integrated display when the data is displayed on the micro-display.

19. A mobile device, comprising:
means for processing data related to a mobile device;
an integrated display to the processing means for displaying the data related to the mobile device;
a micro-display coupled to the mobile device; and
means for creating a virtual display having a larger appearance than the integrated display when the micro-display is positioned proximate to an eye.

20. The mobile device of claim 19, wherein the means for creating the virtual display comprises optically coupling an optical element to the micro-display.
